(19) United States
(12) Patent Application Publication
(10) Pub. No.: US 2013/0061731 A1
(43) Pub. Date: Mar. 14, 2013

(54) DIAMOND WIRE FOR CUTTING HARD MATERIALS

(71) Applicants: Jesus Amador Martin, Usurbil (Gipuzkoa) (ES); Inigo Iturriza Zubillaga, Usurbil (Gipuzkoa) (ES)

(72) Inventors: Jesus Amador Martin, Usurbil (Gipuzkoa) (ES); Inigo Iturriza Zubillaga, Usurbil (Gipuzkoa) (ES)

(73) Assignee: W.DIAMANT HERRAMIENTAS, S.A., Ursurbil (Gipuzkoa) (ES)

(21) Appl. No.: 13/635,233

(22) PCT Filed: Mar. 17, 2010
(86) PCT No.: PCT/ES10/70157

§ 371 Date: Nov. 28, 2012

(51) Int. Cl. B23D 61/18; B28D 1/08

(52) U.S. Cl. 83/651.1; 125/39

(57) ABSTRACT

The invention relates to a diamond wire of the type used in single- or multiple-wire machines for cutting blocks of hard materials, such as stone, concrete, metal or similar, in order to obtain sheets with a thickness of between 2 and 3 cm. The structure of the wire comprises a steel cable and a number of beads distributed along the length of the cable, as well as a plastic coating which is applied to the cable and secures the heads in relative positions both in terms of the longitudinal movement and rotation thereof in relation to the cable. The invention is characterised in that: each bead comprises a generally cylindrical single body of diamond material including an axial passage provided with various formations in the form of angularly equispaced ribs that project inwards and extend longitudinally; and that the external surface of the cylindrical body includes multiple corresponding angularly equispaced channels that also extend longitudinally.

### CROSS-REFERENCE TO RELATED APPLICATIONS

The present application is a U.S. National Stage of International Patent Application No. PCT/AT2010/000392 filed Oct. 13, 2010, and claims priority under 35 U.S.C. §§119 and 365 of Austrian Patent Application No. A 1892/2009 filed Nov. 27, 2009.

### BACKGROUND OF THE INVENTION

1. Field of the Invention

The invention relates to a method for producing reversible knives, in particular for a use in chopping machines for wood chipping, with a profiled cross section having a proximal support part with at least one fitting for fastening the knife in a detachable and displacement-proof manner and distal chipping regions having cutting edges on both sides on the support part. A preliminary material with large longitudinal extension is subjected to a surface processing and a support profile is formed therefrom by rolling.

2. Discussion of Background Information

The prior art includes reversible knives of the type described above in different embodiments. The embodiments mainly represent advantageous economical and/or technical innovations with respect to a special property profile of the knives.

EP 0 271 481 A, for example, discloses a method for producing in particular machine blades of hot-rolled flat steel, wherein a roll tab with homogeneous material structure in the cutting edge region is formed essentially on the side surface by overfilling the last groove.

From DE-OS-27 04 999 a method is known for producing strip-steel knives in continuous passage, wherein the strip is provided with a central groove or flute and the strip is guided on this groove or flute through the following work zones.

A reversible knife that can be used in a knife carrier in a predetermined position by projections or recesses interacting in terms of fit, and two welded-on working parts distal in cross section with blades of high-alloy tool steel, is disclosed by document AT 398 401 B.

Flat-steel knives with a rear end part optionally pressed on or a curved end part for attachment, which is positioned opposite the blade part, formed of tool steel, with a cutting edge are known from US 2009/021 7794 A1.

Reversible knives of the referenced type have economical disadvantages due to a complex production method and/or disadvantages of inadequate product quality or a lack of individual desired use qualities.

### SUMMARY OF THE EMBODIMENTS

Embodiments of the invention are directed to a generic method for producing reversible knives, by which the property profile thereof is optimized economically even with harsh stresses in use.

Accordingly, a method of the type mentioned at the outset includes that the distal regions of the support part, which are worked in an overfilled rolling groove and have a large longitudinal extension, are removed in passage to respectively form processed or bonding surfaces axially symmetrical in the longitudinal direction. Subsequently, attachment parts of tool steel are attached to these processed surfaces of the support part by metallic bonding. From the attachment parts, chipping regions with blade regions and cutting edges are shaped by chip removal. In edge regions, a thermal material treatment and subsequently a cutting to length takes place for reversible knives ready for operation.

The advantages achieved with the method according to the invention are essentially due to the fact that proximal fittings and distal regions of the support part are simultaneously formed from the preliminary material by rolling in an overfilled groove. The distal parts far towards the longitudinal axis have a cold-worked, essentially unoriented structure and consequently a preferred strengthening of the material. These distal hardened parts, partially pressed out of the groove, are removed essentially at room temperature and a flat surface is formed, so that it is ensured that the strength of the material achieved by cold working is retained in the flat region.

Attachment parts of tool steel are metallically connected to the surfaces of the support part formed in this manner. The connection or welding is carried out in a high-energy manner, that is, without disadvantageous depth action. In this manner, only an unimportant reduction in strength of the material of the support part hardened by cold working is achieved in the connection region, which produces a desired high mechanical stability of a fixing of the attachment part.

A forming of a chipping region with a cutting edge takes place respectively on the attachment parts by cutting, optionally in combination with partial cold working, wherein a high-strength connection to the support part is maintained.

A thermal material hardening and tempering of the edge region is thereby provided such that no heat affecting of the zone with the metallic bond or welding without any additional materials takes place on the attachment part.

A final sharpening of the blade and a cutting to length of the knives can now take place in a simple manner.

In an embodiment of the invention, it is advantageous if the preliminary material with large longitudinal extension, after a dimensionally exact processing of the surface thereof and before a rolling to form a support part, is heated by a rapid heating in a period of less than 50 sec., in particular of less than 15 sec., preferably by induction heating, in passage to a temperature of less than 900° C. with the proviso that the structure of the material remains in a cubic body-centered atomic structure. In this manner, by a directly upstream dimensionally exact processing of the surface, an exact dimensioning of the preliminary material and thus a precise definition of the dimensions of the rolled product, on the one hand, and, on the other hand, a high quality non-scaling surface quality of the support profile, in particular the adjacent surfaces of the fitting means, take place. To avoid a disadvantageous oxide formation, it is advantageous for the preliminary material to provide a rapid heating in a period of less than 50 sec., which heating is preferably carried out by induction in passage. A maximum temperature for shaping the preliminary material is determined by the chemical composition or by the carbon content of the material. For a work hardening of the material during the shaping, at most a temperature is necessary at which a recrystallization of the structure is avoided and thus a forming of the part takes place in the temperature range with cubic body-centered atomic structure.

In order to achieve favorable conditions for a connection of the attached parts by fusion welding without any additional material with a small heat-affected zone, it can be advantageous with respect to a good adhesion and a precise consistence over the longitudinal extension if axially symmetrically distal regions are removed from the shaped support part during its guidance by the fittings in passage with the formation of processed flat surfaces, wherein the width of the surfaces is more than 0.9 mm but less than 2.9 mm.

It is thereby advantageous in terms of bonding technology if with a shift in the longitudinal axial direction and with guidance of the support part by the fittings, this is metallically fixed with attachment parts of tool steel with a thickness of more than 0.9 mm but less than 2.9 mm and a width of 1.0 mm to 4 mm by fusion without any additional material, in particular by laser welding.

Advantageously, the carbon content of the usually low-alloy support part is to be oriented to the carbon activity of the attached parts established by alloying technology, in order to keep low or inactive a carbon diffusion to the high-alloy tool steel and thus a danger of a formation of a brittle region in the welding zone.

If the attached parts on the support part are further developed by cutting and/or by non-cutting shaping to form chipping regions essentially triangular in cross section with cutting edges, the mechanical stresses in the region of the connection zone can be minimized in a favorable manner and the material strength therein can be increased.

Advantageously, the blade regions with the cutting edges on the chipping part after a final machining to the axially symmetrical precise representation of the cutting edges in passage are subjected to a thermal material quenching and tempering by hardening and quenching the blade region of tool steel. In this manner desired properties and hardness values of the blade regions with respect to the field of use of the knives can be adjusted. However, it is necessary thereby to restrict the material quenching and tempering of the tool steel to the blade region and to avoid a disadvantageous heating of the chipping part in the region of the weld seam because an embrittling therein can lead to a breakage of the metallic bond.

It can be favorable for economic reasons if optionally from an intermediate storage a support part with great longitudinal extension after shaping of the distal chipping and blade regions and a thermal quenching and tempering of the regions with the dressed cutting edges is cut to length and finally formed to produce reversible knives ready for use.

Embodiments of the invention are directed to a method for producing reversible knives with a profiled cross section that includes a proximal support part with at least one fitting for fastening the knife in a detachable and displacement-proof manner and distal chipping regions having cutting edges on the support part. The method includes forming the support part by processing a preliminary material with a longitudinal extension, removing distal regions of the support part to form processed surfaces axially symmetric in a longitudinal direction, attaching attachment parts to the process surfaces, shaping the distal chipping regions from the attachment parts to form blade regions with the cutting edges, treating at least edge regions of the distal chipping parts with a thermal material treatment, and cutting the reversible knives to a desired length.

According to embodiments, the reversible knives can be structured for a use in chopping machines for wood chipping.

In accordance with other embodiments of the invention, the distal regions are longitudinal extensions resulting from working the preliminary material in an overfilled rolling groove.

According to other embodiments, the attachment part is tool steel. Further, the attachment parts are attached to the processed surfaces by metallic bonding.

In accordance with embodiments, the distal chipping regions are shaped by at least one of chip removal and cold forming.

According to further embodiments, the processing of the preliminary material includes a surface processing of the preliminary material and a rolling of the preliminary material. After the surface processing and prior to the rolling, the method further includes heating the preliminary material by a rapid heating in a period of less than 50 sec. to a temperature of less than 900° C., wherein the structure of the material remains in a cubic body-centered atomic structure. Further, the rapid heating period can be less than 15 sec. Moreover, the heating of the preliminary material may include induction heating.

In further embodiments, the removing of the distal regions can occur while the shaped support part is guided by the fittings and the formed processed surfaces are processed flat surfaces having a the width of more than 0.9 mm but less than 2.9 mm.

Further, the formed support part can be guided in a longitudinal axial direction, and, prior to attaching the attachment parts, a shift occurs in the longitudinal axial direction and the support part is guided by the fittings. The attachment parts, having a thickness of more than 0.9 mm but less than 2.9 mm and a width of 1.0 mm to 4 mm, can be metallically fixed to the support part when attaching to the processed surface. The attaching may include fusion without any additional material. Still further, the attaching can include laser welding.

According to still other embodiments, the shaping of distal cutting regions can include at least one of cutting shaping and non-cutting shaping. The distal chipping regions are shaped with essentially triangular cross-sections and cutting edges.

In accordance with still other embodiments of the instant invention, the blade regions can include tool steel and a final machining of the blade regions to an axially symmetrical configuration of the cutting edges can occur prior to the treating with a thermal material treatment, which may include quenching and tempering at least part of the blade region. The thermal material treatment can include quenching and tempering dressed cutting edges of the blade region.

In accordance with still yet other embodiments of the present invention, the support part can have a longitudinal extension from which the reversible knives are cut to a desired length after the shaping of the distal chipping regions and after the treating of the at least edge regions. In this manner, the reversible knives are ready for use. Moreover, the treating of the at least edge regions may include thermal quenching and tempering of dressed cutting edges of the distal chipping parts.

### BRIEF DESCRIPTION OF THE DRAWINGS

The invention is described in more detail below based on drawings which are intended to illustrate a production process for knives, and on exemplary embodiments, which show only one way of carrying out the invention.

The graphical representations show

FIG. 1 illustrates a preliminary material;

FIG. 2 illustrates a shaped support part (or support profile body);

FIG. 3 illustrates a processed support part;

FIG. 4 illustrates a support part with attached part;

FIG. 5 illustrates a support part with chipping region; and

FIG. 6 illustrates a reversible knife.

### DETAILED DESCRIPTION OF THE EMBODIMENTS

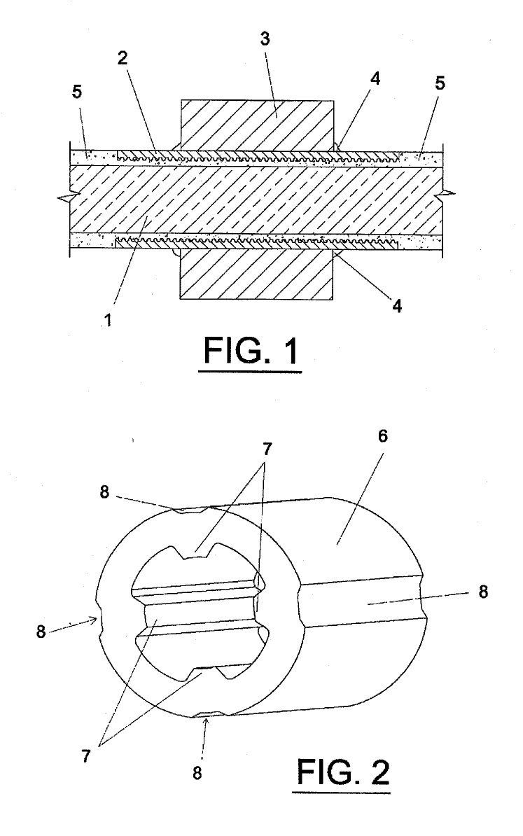

FIG. 1 shows a cylindrical preliminary material 1 with a processed surface 11 with a rough depth R_{y}, (R_{z} ISO) of less than 45 μm.

FIG. 2 shows a support profile (or carrier) body 2 (also referred to as simply a support part) shaped by rolling with an overfilled groove. The support profile body 2 in the distal regions respectively has a roll tab 23. During rolling, fittings 21, 22 with a concave shape 21 and a convex 22 shape have been worked proximally at the same time into the support profile body 2.

FIG. 3 shows diagrammatically the support profile body 2 further processed by separating the distal roll tabs 23 to produce or form processed surfaces 3.

FIG. 4 shows in a schematic illustration respectively one an attached part 4 fixed to the support profile body 2. Support profile body 2 and attached part 4 are fused together without any additional material by metallic bonding 41, in particular by laser welding.

FIG. 5 shows respectively a chipping part 5 formed by processing an attached part 4. Chipping part 5 includes a blade region 51 distanced from the bond or a weld seam 41.

FIG. 6 shows diagrammatically a knife W cut to measured length comprising a support profile body 2 with proximally positioned fittings 21, 22 comprising a concave indentation 21 shaped in the knife axial longitudinal direction and a convex projection 22 lying opposite the concave indentation 21. Further, attached parts 4, which are permanently attached to the support profile body 2 distally by metallic bonding 41, are further developed to form chipping parts 5 with thermally hardened blade (or chipping) regions 51 with cutting edges 52.

By practical tests, so-called “trimetal” reversible knives of a support profile body 2 formed of high carbon steel and a chipping part 5 comprising a high-speed steel alloy EN/DIN material no. 1.3247 or AISI-M42 hardened and tempered to a hardness of 65 HRC in the blade region 52 were examined and tested practically in a hard insert.

Test results showed that, above a certain carbon content of the support profile body 2 material, a carbon diffusion towards the tool steel part in the connection region between support profile body 2 and attached part 4 (processed into chipping part 5) at metallic bonding 41 can take place depending on temperature and time. In this manner, brittle regions formed in the weld seam can cause the chipping parts 5 to break loose.

Support profile body 2 of carbon steels with a low C concentration of less than 0.35% by weight showed this danger to a much lower extent. A prior strengthening of the material caused by cold working at a temperature in the alpha range of the alloy provides sufficient toughness and strength properties for extreme stresses of the knives even after an attachment by welding of attached part 4.

1. (canceled)

2. A diamond wire for cutting hard materials, comprising:
a steel cable; and
a plurality of diamond beads placed in predefined positions along a length of the steel cable and positionally fixed in relation to the steel cable a longitudinal direction and in a rotational direction.

3. The diamond wire according to claim 2, further comprising at least one of a plastic or rubber casing applied to cover exposed parts of the cable and to penetrate into an interior of each diamond bead to couple the diamond bead to the cable surface.

4. The diamond wire according to claim 2, wherein each diamond bead comprises a body having an axial hole through which the cable is passable, the axial hole having an internal surface from which angularly equidistant ribs protrude and extend in the longitudinal direction of the body.

5. The diamond wire according to claim 4, wherein the body comprises a diamond material of generally cylindrical shape.

6. The diamond wire according to claim 2, wherein the body has an external surface in which are formed several angularly equidistant grooves extending in the longitudinal direction of the body.

7. The diamond wire according to claim 2 being structured and arranged for cutting of blocks of hard materials at least in one of in quarries or for obtaining slabs having a predefined thickness.

8. The diamond wire according to claim 7, wherein the blocks of hard materials comprise blocks of stone, concrete, or metal.

9. The diamond wire according to claim 7, wherein the diamond wire is positionable in at least one of a mono-wire and multi-wire machine.

10. The diamond wire according to claim 3, wherein each diamond bead comprises a body having an axial hole through which the cable is passable, the axial hole having an internal surface from which angularly equidistant ribs protrude and extend in the longitudinal direction of the body.

11. The diamond wire according to claim 10, wherein the body comprises a diamond material of generally cylindrical shape.

12. The diamond wire according to claim 11, wherein the body has an external surface in which are formed several angularly equidistant grooves extending in the longitudinal direction of the body.

13. The diamond wire according to claim 12 being structured and arranged for cutting of blocks of hard materials at least in one of in quarries or for obtaining slabs having a predefined thickness.

14. The diamond wire according to claim 13, wherein the blocks of hard materials comprise blocks of stone, concrete, or metal.

15. The diamond wire according to claim 13, wherein the diamond wire is positionable in at least one of a mono-wire and multi-wire machine.
